(19) United States
(12) Patent Application Publication
(10) Pub. No.: US 2013/0231968 A1
(43) Pub. Date: Sep. 5, 2013

(54) Method and System for Identifying Management Zones for Variable-Rate Crop Inputs

(71) Applicant: PHANTOM AG LTD., Naicam (CA)

(72) Inventor: Corwyn Willness, Naicam (CA)

(73) Assignee: PHANTOM AG LTD., Naicam (CA)

(21) Appl. No.: 13/740,780

(22) Filed: Jan. 14, 2013

(30) Foreign Application Priority Data
Mar. 2, 2012 (CA) 2770216

(51) Int. Cl. G06Q 50/02

(52) U.S. Cl. CPC G06Q 50/02; G06Q 10/0631
USPC 705/7.12

(57) ABSTRACT

A method and system for identifying management zones for variable-rate crop inputs, wherein the zones are developed using soil, water and topography base maps. The base maps are combined into various different zone maps, and a final zone map is selected on the basis of observed field characteristics.

### CROSS-REFERENCE TO RELATED APPLICATIONS

This application claims priority from Canadian Patent Application 2770216 filed on Mar. 2, 2012 which is hereby incorporated by reference in its entirety.

### BACKGROUND OF THE INVENTION

1. Field of the Invention

The present invention relates to methods and systems for managing crop inputs such as fertilizer in large agricultural fields, and more specifically to the analysis of field characteristics to help determine prescriptions for crop input levels.

2. Related Art

It is well known that productivity demands on agricultural land have been increasing and therefore requiring new and enhanced methods for extracting greater yield from existing fields. Increased global environmental concerns have also prompted agricultural practices to recognize that air, water, and soil stewardship are as important as safe and healthy food production. This has resulted in the development and deployment of various enhancement technologies, such as more effective fertilizers and methods for treating fields. While the new technologies and methods can increase productivity, they also introduce additional cost that can be prohibitive if not managed properly.

An additional complicating factor is that a particular field is not normally uniform in characteristics across its entire extent. Variations in soil type and conditions, elevation, water flow patterns and the like mean that different areas of a target field will require different treatment levels to achieve a target productivity. It is therefore obvious that treating a target field as a uniform entity can result in overuse of crop inputs in some areas and accordingly an undue expenditure and environmental liability. Under-application in some areas results in wasted resources of sunlight and water as well as lost profitability.

Various methods and systems have been taught for taking account of field variability in determining a target crop input level based on a defined end goal. For example, Canadian Patent No. 2,392,962 to Hanson teaches a method that employs satellite imagery to determine crop density, which in turn is used to identify yield potential. Yield potential and soil conductivity measurements are used to define management zones, which are then utilized to illustrate condition variability across a target field, and soil samples are taken for each of the identified management zones. The stated purpose of Hanson is to reduce the number of soil samples required for a target field, as sampling costs can be significant in large fields. After reduced sampling occurs, a prescription for crop inputs can be generated.

As a further example, Canadian Patent Application No. 2,663,917 to Schmaltz and Melnitchouk teaches the use of satellite imagery to determine differences in plant biomass densities across a target field. This allows the identification of plant production zones, which are grouped into soil management zones. For each soil management zone, residual nutrients in the soil are compared against an optimal target level, with any shortfall subsequently used in providing a crop input prescription for each zone in the target field.

However, it has been found that existing methods may not always provide an optimal crop input prescription that places emphasis on the conditions most likely to influence yield in a particular target field that has variability largely due to soil, water, and topography. What is needed, therefore, is a method for identifying management zones that reflect the soil, water, and topography field characteristics most likely to impact crop inputs for a given field.

### SUMMARY OF THE INVENTION

The present invention therefore seeks to provide a method and system for identifying management zones for variable-rate crop inputs, wherein the zones are developed using soil, water and topography base maps. The base maps are combined into various different zone maps, and a final zone map is selected on the basis of observed field characteristics.

According to the present invention, soil-based data is used to generate soil maps and elevation-based data is used to generate water maps and topography maps. These soil, water and topography maps are then combined in various ways to generate a plurality of zone maps, which merge different attributes from the soil, water and topography maps in different proportions. The plurality of zone maps go through a “truthing” process which allows comparison of the plurality of zone maps against actual field observation data to determine which of the zone maps most accurately reflects those field characteristics most likely to have the primary impact on crop input recommendations. In this way, and unlike prior art methods, observed field data can be used to select which of the zone maps will be more likely to enable an optimal crop input prescription, whereas with prior art methods a single map is generated based on set criteria that may or may not fully reflect overriding field characteristics. Each zone map illustrates field characteristics by using a particular zone definition system based on soil and elevation based criteria, again unlike the prior art methods. Remote sensing of plant density is not used to build these zone maps, as fields with a high degree of soil, water, and topography variability will respond differently under various environmental conditions. For example, a water collection area may have a low plant biomass and yield in a wet year due to flooding but may have a high plant biomass and yield in a dry year as the extra moisture provided improved yields. Conversely, if a water collection area has a high salt content it will have low yields in all years. Maps that can define multiple features of areas within the field and define what the primary source of variability is likely to be can thus provide a clearer understanding of how these areas are most likely to respond to crop inputs.

A detailed description of an exemplary embodiment of the present invention is given in the following. It is to be understood, however, that the invention is not to be construed as being limited to this embodiment.

### BRIEF DESCRIPTION OF THE DRAWINGS

In the accompanying drawings, which illustrate an exemplary embodiment of the present invention.

FIG. 1a is a flowchart illustrating a method according to the present invention from soil and elevation data collection through generation of the plurality of zone maps.

FIG. 1b is a flowchart illustrating a method according to the present invention from the truthing process through to generation of a crop input prescription.

FIG. 2 is an illustration of a print-out showing a zone map and related information.

FIG. 3 is a functional block diagram of an exemplary data processing system that can embody the data processing methodologies of the present invention.

An exemplary embodiment of the present invention will now be described with reference to the accompanying drawings.

### DETAILED DESCRIPTION OF EXEMPLARY EMBODIMENT(S)

Soil, water and topography attribute data collection is employed to identify management zones for variable-rate crop inputs. Crop inputs include but are not limited to fertilizer, seed, pesticide, and soil remediation products. The method according to the present invention includes the collection of soil and elevation based field data and the generation of base maps reflecting such data. The base maps are combined in several different ways to generate a plurality of zone maps which each highlight different aspects of the base map information and illustrate those aspects. Based on actual field observation data, a specific zone map is selected that best represents the predominant field aspects that are most likely to have the greatest impact on crop inputs and field productivity.

An exemplary method and system according to the present invention is set out below with reference to the accompanying drawings.

### Method

Data Collection. The first step in the exemplary method is the collection of in-field or remote data regarding soil, water and topography attributes of a target field.

Soil attributes are derived from the collection of soil based data. Soil attributes could include, but are not limited to: texture, organic carbon, organic matter, pH, structure, erosion, salt levels, and topsoil depth.

Water and topography attributes are derived from the collection of elevation based data. Water attributes include, but are not limited to: water sheds, water flow paths, water collecting areas, water shedding areas, aspects and slopes. Topography attributes include, but are not limited to: raw elevation, elevation variant combinations, knolls, shoulder slopes, mid-slopes, foot slopes, depressions, and topography variant combinations.

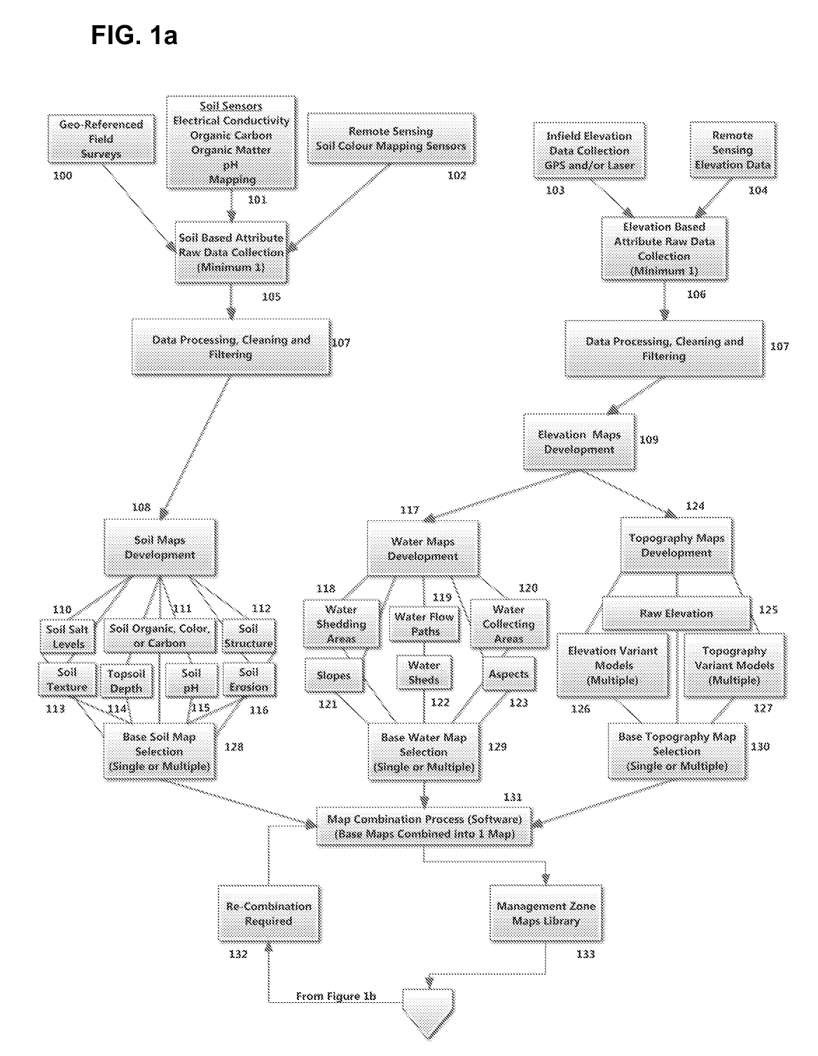

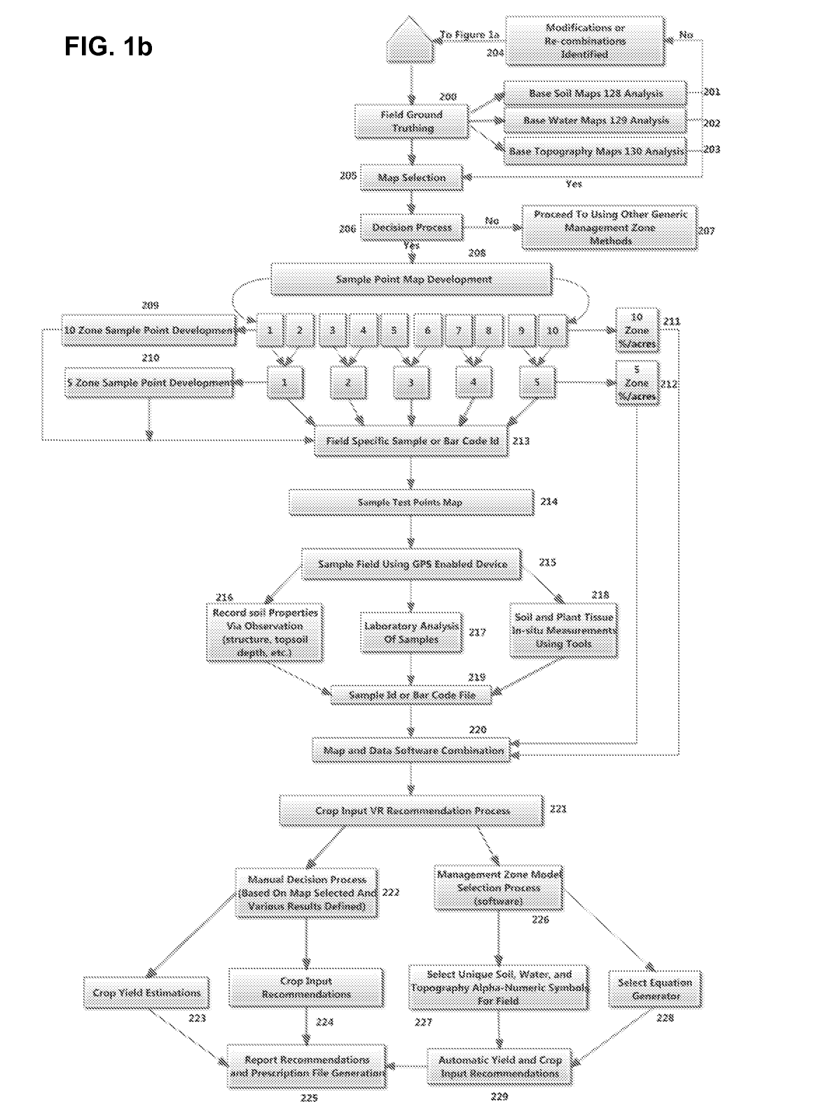

Turning to FIG. 1a, soil based raw data collection 105 can be accomplished through three different methods. The three methods are field surveys 100, soil sensors 101 and remote sensing 102. These processes can be utilized individually or in combination, so long as the desired soil based raw data can be acquired. Field surveys 100 can be historical, such as government or university publications that describe the soil properties in specific areas of a particular field at a point or points in the past. These soil properties are described in detail and are related to similar soils found in designated soil classification areas. Such publications generally include a map that can be subsequently geo-referenced. Current field surveys can also be conducted that could include the use of a GPS (global positioning system) unit, soil penetrometer, soil pH measurements, and soil profile characterization. Soil sensors 101 are mechanized data collection tools, commonly connected to a GPS unit and equipped with instruments to measure soil based properties, such as but not limited to: pH, soil colour, electrical conductivity, organic carbon and organic matter. Remote sensing 102 is commonly achieved through the use of satellites, aircraft or drones equipped with multi-spectral cameras. The data generated by these instruments is recorded by a data-logger that is connected to a GPS unit so that spatial definition can be applied to the data collected. Where such photogrammetric pictures are used with the present invention, they must be of soil, not crop biomass. A minimum of 1 (no maximum) high quality data set that accurately defines the soil attributes is required.

In-field elevation data collection or remote sensing is used to establish elevation based raw data collection 106. As is known in the art, elevation data must be of very high quality to accurately depict water and topography features; sub-inch accuracy is optimal but in some landscapes less accurate data may be used. In-field elevation data collection 103 can include but is not limited to Real Time Kinematics (RTK). The data collection vehicle, such as a pickup truck or all-terrain vehicle, is fitted with a GPS antenna and receiver. An onboard data logger records elevation points as the vehicle surveys the field. Aircraft, satellites or drones can also be used as remote sensing data collection means 104 for elevation based attribute collection, and they can be provided with sensors capable of producing accurate Digital Elevation Models (DEM). A minimum of 1 (no maximum) high quality data set is required for the soil data collection 105 and for the elevation data collection 106.

Data Cleaning. Once the soil and elevation data has been collected in its raw form, it must undergo data processing, cleaning and filtering 107 to remove irregularities that occur during the data collection process. Such data cleaning can employ automated or manual techniques well known in the art. Cleaned data is saved to a new file so that the collected data is always maintained in its original raw condition if later required.

Soil Maps Development and Selection. Soil maps are then developed 108 from the dataset of cleaned soil based data. The soil maps can include visual depictions of, but are not limited to, any or all of the following characteristics: soil salt levels 110, soil -organic, -colour, and -carbon 111, soil structure 112, soil texture 113, topsoil depth 114, soil pH 114 and soil erosion 116 properties. Various commercially available software-based statistical and analytical tools can be used to generate the soil maps. The soil maps are then assessed against actual field observation data, which assessment can be achieved through automated or manual means, to see which soil maps best visually reflect the actual soil properties. The soil map(s) that best represent the soil characteristics of the field will then be selected as base soil map(s) 128 for use with the software-based map combination process 131. If a certain soil attribute is found to be overwhelming in terms of anticipated crop input determinations in a particular area, for example if the soil turns out to have a high salt content, it should be the focus of the selected base soil map for that area.

Water Maps Development and Selection. Elevation maps are then developed 109 from the dataset of cleaned elevation based data. Water maps 117 and topography maps 124 are developed through this process. The water maps can include visual depictions of, but are not limited to, any or all of the following characteristics: generating water shedding areas (knolls) 118, water flow paths 119, water collecting areas (depressions) 120, slopes 121, watersheds 122 and aspects 123. Various commercially available software-based statistical and analytical tools can be used to generate the water maps. The water maps are then assessed against actual field observation data, which assessment can be achieved through automated or manual means, to see which water maps best visually reflect the actual observed field properties. The water map(s) that best represent the characteristics of the field will then be selected as base water map(s) 129 for use with the software-based map combination process 131. If a certain elevation based water attribute is found to be overwhelming in terms of anticipated crop input determinations, it should be the focus of the selected base water map.

Topography Maps Development and Selection. The topography maps 124 can include visual depictions of, but are not limited to, any or all of the following characteristics: raw elevation 125 and elevation variants 126. Known software based models or topography variants, software algorithms, and mathematical functions are applied to the raw elevation data to model several other elevation and topographical variant maps 127 based on the elevation data. Various commercially available software-based statistical and analytical tools can be used to generate the topography maps. The topography maps are then assessed against actual field observation data, which assessment can be achieved through automated or manual means, to see which topography maps best visually reflect the actual observed field properties. The topography map(s) that best represent the characteristics of the field will then be selected as base topography map(s) 130 for use with the software-based map combination process 131. If a certain elevation based topography attribute is found to be overwhelming in terms of anticipated crop input determinations, it should be the focus of the selected base topography map.

Map Combination Process. The base soil maps 128, base water maps 129 and base topography maps 130, described above, are merged using commercially available software in a map combination process 131, where different soil, water and topography attributes of the target field are merged in different proportions to render a plurality of distinct management zone maps that illustrate soil, water and topography features. The plurality of management zone maps is stored in a management zone maps library 135. One of the plurality of management zone maps will be selected as best representing the relevant field attributes 205, which is described in detail below as part of the truthing process.

Each management zone map is a visual rendering of an agricultural field where regions of the field with similar attributes are grouped together, such attributes including but not limited to landscape position, water runoff and collection characteristics, soil textural characteristics, organic carbon levels and salt levels. These different regions (the zones) are visually defined using a red/yellow/green colour legend. While the zones may be established using different definitions, one exemplary zone definition is based on the following traits:

Zone 1 (dark red) Lowest soil moisture, lowest organic carbon levels, lowest soil nutrient levels; potentially wind and water eroded areas; sand or loam soil texture, thinnest topsoil, highest elevation, hills and knolls landscape positions.

Zone 2 (light red) Gradient between Zones 1 and 3.

Zone 3 (dark orange) Low soil moisture, low organic carbon levels, low soil nutrient levels; potentially light wind and water eroded areas; loam soil texture, thin topsoil, shoulder-slope landscape positions.

Zone 4 (light orange) Gradient between Zones 3 and 5.

Zone 5 (yellow to orange) Median soil moisture, median salt levels, median soil texture, median organic carbon levels, median topsoil thickness, median elevation such as mid-slope landscape positions, typically deemed as field average soils.

Zone 6 (yellow) Gradient between Zones 5 and 7.

Zone 7 (yellow-green) Light water collection and erosion, medium to high salt levels, clay loam or clay soil texture, medium to high organic carbon levels and thick topsoil. Foot-slope landscape positions. Possibly water flow accumulation areas with erosion and/or light topsoil accumulation.

Zone 8 (light green) Gradient between Zones 7 and 9.

Zone 9 (dark green) Gradient between zones 8 and 10.

Zone 10 (darkest green) Heaviest water collection area, clay soil texture, highest topsoil erosion accumulation, highest salt levels, highest organic carbon levels, highest soil nutrient levels, and deepest topsoil thickness. Lowest elevations and depressions.

These zone definitions are for general application and may not apply to a particular target field. Depending on the variability of soil, water and topography attributes, a target field may contain as few as one of these attributes while others may include many of these attributes. For example, a particular field may have sand soil texture, low organic carbon content, thin topsoil, and very high elevation hills in zone 1 and loam textures, high organic carbon content, and thick topsoil in low elevation depressions in zone 10. A comparison field may be relatively flat with very little topography but has loam textures in zone 1 and clay texture and very high salt content in zone 10. Each field has its own unique characteristics that define what components dominate the soil, water, and topography variability.

Truthing Process and Zone Map Selection. Turning to FIG. 1b, a field ground truthing process 200 is implemented to identify the management zone map that best represents the target field 205. Field data (from actual field observation data or an in-field examination) are compared against the plurality of management zone maps stored in the library, while also referring to the base soil maps 201, base water maps 202 and base topography maps 203 that formed the basis of those management zone maps. This comparison and review is enabled by viewing the management zone maps and base maps on a computer capable of opening these various layers; if the comparison is based on in-field examination, the computer should be GPS-enabled and provided with Geographic Information System (GIS) software capable of opening these various layers. If it is determined that none of the management zone maps adequately reflects the salient field attributes based on the field data, potential base map re-combinations are identified 204 and performed 132 (of FIG. 1a) and the new management zone maps are put through the truthing process 200. For example, the management zone map may stress elevation based features, but examination of actual field data might reveal that the soil variability is more relevant to a variable-rate crop input recommendation for the particular target field. Once a management zone map is identified that reflects the salient field attributes based on the field data, a decision must be made 206 as to whether the process has generated a field management approach that will be useful in generating a variable-rate crop input recommendation. In other words, the purpose of the overall process is to provide a variable-rate crop input prescription, and if the process does not enable such recommendations then other management zone methods may be better suited to the particular target field 207. For example, it may be determined that the soil, water and topography variability is not significant enough to justify managing the crop inputs as variable for that target field. If the management zone map is reflective of the field attributes and enables a determination of field attribute variability, and that variability is significant enough to justify management, the process proceeds to sampling and prescription.

Sampling. Referring to FIG. 1b, once the final management zone map has been selected, a sample point map is developed 208. The sample map is used to take representative samples from each of the management zones 210 or for groupings of zones 209. Where, as in the exemplary zone definition discussed above, there are ten defined zones, the sampling would therefore either be for ten individual zones or a combination of those zones; in FIG. 1b the zone combination results in five combined sampling zones. The number of test points varies depending on the actual type of sampling (soil versus plant) and the size of the field (hectares/acres), as would be clear to one skilled in the art. The quantity of hectares/acres and their relative percentages, for either the ten-zone approach 211 or the five-combined-zone approach 212, represented in each management zone, is calculated by software in a manner known in the art, and this hectare/acre determination is used for variable-rate crop input calculations. Unique sample ID codes are generated 213 by the user that will connect the field database in the record keeping software to the files from laboratory analysis or field instruments used for sampling, that correspond with the target field and each management zone test point within that field, and these ID codes will match sample collection identification in each management zone to the software. A sample test points map 214 is then generated with software in the office or in the field by the user and opened on a GPS-enabled computer with appropriate GIS software to view the map, and samples are taken at each test point within the field 215. The sampling operator makes observations and notes of the sample characteristics as they are being collected 216, such as but not limited to structure, topsoil depth, and crop growth, and records these findings in the software for future reference 220. This collection of samples may be sent to a laboratory 217 for testing of properties such as soil nutrients or plant tissue. Soil and plant tissue in-situ measurements 218 can also be taken using known tools such as pH meters, chlorophyll meters, and water content testers. The appropriate sample ID codes are attached to all samples taken 219 and are utilized when importing and recording lab analysis results and in-situ GPS measurements into the software 220.

Prescription. Data will be collected and input into the software 220 to enable the generation of a variable-rate crop input recommendation. The data collection includes, but is not limited to: soil test analysis results data, objective observation notes, crop history, cropping intentions, variable-rate application equipment configurations, and soil survey data. The data is then available for the variable-rate input recommendation process 221. Variable-rate input recommendations can be realized through a manual decision process 222, where all recommendations are entered manually. Variable-rate input recommendations can also be selected from an automated software model selection process 226.

In the manual decision process 222, consideration is given to factors that could influence the prospective crop, including information saved in the software, past agronomic experience associated with crop production in the local area, weather (heat, rainfall and temperature forecasts for the growing season) and the particular farmer's crop input budget. Crop yield estimations 223 are then inputted into the software 225 for reporting purposes. Crop inputs 224 such as fertilizer rates and/or seed rates and/or pesticide rates are also entered into the database software for the purpose of generating a report and a prescription file for variable-rate crop input recommendations 225. For steps 222, 223 and 224, all of these data entries are done manually.

In the automated management zone modelling process, variable-rate crop input recommendations are suggested by a software model 226 exclusive to the croprecords.com software and system. This model uses unique soil, water, and topography alpha-numeric symbols 227 based on properties defined by ground-truthing 200, base maps 201, 202, and 203, management zone map selection 205, and field analysis and observations 216, 217, and 218. The purpose of this model is to simplify crop input recommendations. If two fields are very similar in their characteristics they can be given the same alpha-numeric name in order for the user to quickly identify the predicted attributes of the fields rather than go through all of the notes, samples, and maps to determine the fields characteristics. These alpha-numeric designations would apply to fields and geographic regions where the attributes of the soil, water, and topography maps have similar qualities that define fields as similar in that area. These designations are given by the user and are unique to the croprecords.com software program for the purpose of this management zone mapping system and process. For example, a Weyb-Solon soil is a brown soil with a low organic matter range, clay to clay-loam soil texture, high salt levels, and prismatic hardpans interspersed throughout, and an NC-Ox is characterized by having eroded knolls, loam soils and lightly saline depressions. The software then calculates the recommendations automatically 229 using the existing analytical test data collected in step 220. The recommendations can be based on equations 228 designed by laboratories (such as Agvise Labs), universities (such as the University of Saskatchewan), or privately developed. Examples include equations developed by calibrating field trials of crops to levels of soil nutrients to aid in prediction of economical application rates of fertilizer for a specified yield goal. The management zone model will automatically calculate the crop input requirements 229 for each of the management zones based on the user-selected alpha-numeric symbols and equations. Variable-rate crop input recommendations are then generated as a report and prescription files are generated by the software for the controller 225.

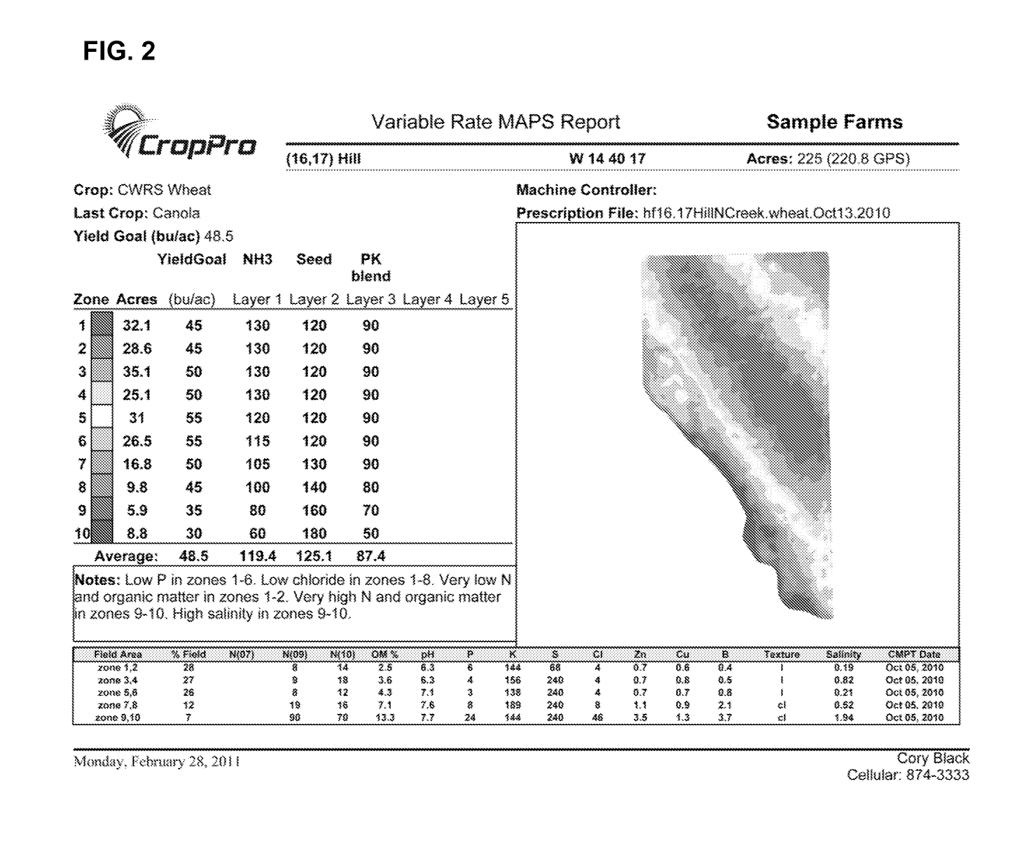

FIG. 2 illustrates a sample of a report for use with a variable-rate crop input controller. The report presents the final management zone map on the right side, analytical results for each zone in the field at the bottom, acreage information on the left side, and crop input recommendations defined by zone (immediately to the right of the acreage information). The operator of the controller and equipment for the crop inputs would then apply the recommended crop inputs based on the zones as defined in the map. If for example the operator is applying granular nitrogen fertilizer, the prescription file on the controller will communicate the appropriate rate for the equipment applicator to apply based on the zone defined rate and the GPS location.

Software. At various points in the above description, software products and their use have been referred to generally. There are various commercially available software products that could meet these needs, as would be known to one skilled in the art. For example, software for data processing, cleaning, and filtering 107, as well as development of soil maps 108, water maps 117, and topography maps 124 and all subsequent maps through map combination 131 can be developed through commercially available software. Depending on the raw data collection techniques for soil based raw data collection 105 and elevation based raw data collection 106, the preferred software for the data may vary, as would be obvious to one skilled in the art. In nearly all cases, multiple programs will generally be required to implement the present invention and produce the desired results. Examples of such commercially available software include but are not limited to: SSToolbox™, SMS Advanced™, Arcview™, Surfer™, HGIS Starpal™, Ag Data Viewer™, Farmworks™, and MapInfo™.

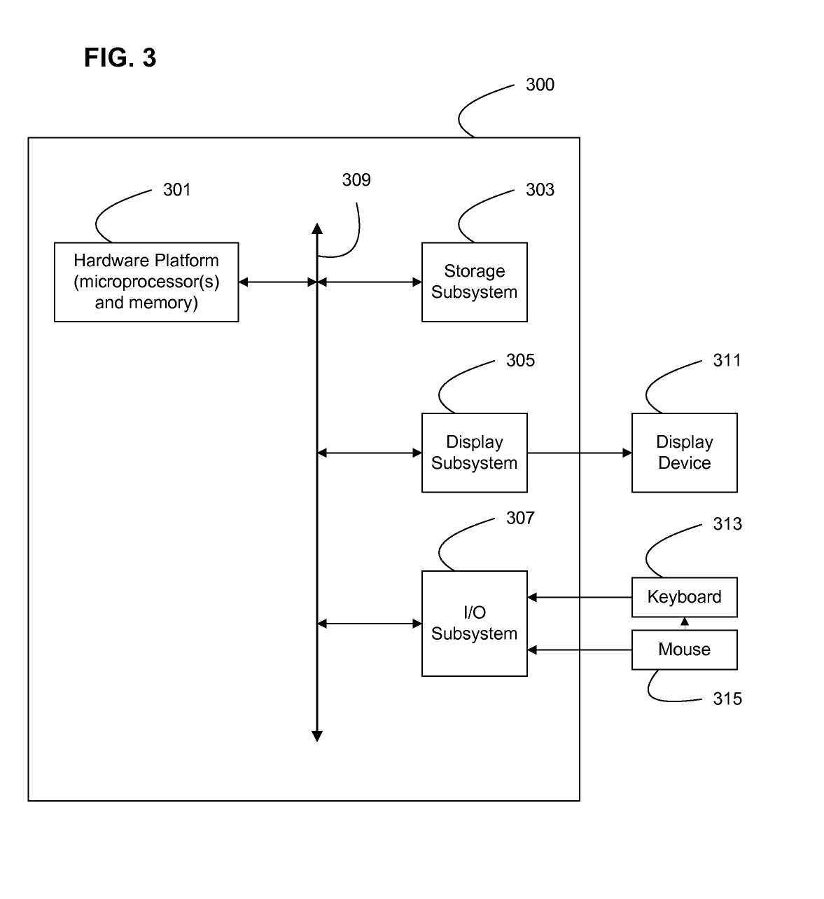

The software-based methodologies and products can be embodied in a computer product (for example, an optical disc or other form of persistent memory such as a USB drive or a network server). The software can be directly loadable into the memory of a data processing system for carrying out the data processing operations as described herein. The data processing system may be realized by a personal computer, workstation or other computer processing system. An exemplary data processing system 300 is shown in FIG. 3. It includes a hardware platform 301 (e.g., a microprocessor and associated memory, typically realized by one or more non-volatile Flash memory modules and one or more volatile DRAM modules), a storage subsystem 303, a display subsystem 305, and an I/O subsystem 307 that interface to one another over a system bus 309. For simplicity of illustration, the system bus 309 is shown as single bus; however, the system bus may be a hierarchical organization of multiple buses as is well known in the arts. The storage subsystem 303 includes one or more hard disk drives (not shown) and/or some other form of persistent storage. The display subsystem 305 includes a display adapter that interfaces to a display device 311 that displays graphical user interfaces and other display screens for interacting with the user. The I/O subsystem 307 interfaces to user input devices (such as a keyboard 313 and mouse 315) for user input as well as to output devices (such as a local printer or speaker or other audio devices) for output. The system can also include a communication subsystem such as a wired or wireless network adapter (not shown) for networked communication to other devices over a LAN or WAN (e.g., the Internet). The data processing system 300 includes software (including an operating system and the software products described herein) that is persistently stored by the storage subsystem 303 (e.g., such as on a hard disk drive), and that is loaded into memory of the hardware platform 301 for execution by the microprocessor(s) of the hardware platform 301. During such execution, the hardware platform 301 cooperates with the display device 311 to display graphical user interfaces and other display screens for interacting with the user in conjunction with user input via the I/O subsystem 307.

Many of these software programs can also be used (or have other modules that could be used) on portable computers provided with a GPS unit or connected to a remote GPS unit for truthing 200 and sampling 214. For developing prescription file generation 225 for various known controllers that operate the application equipment, several software programs may also be required as there is a great diversity of file types and file name structures required, as again would be known to those skilled in the relevant art. Software that produces reports, tracks production, and imports and connects soil and plant tissue test results to the appropriate field may include the above programs as well as others such as AgExpert™ and croprecords.com, which is the software used to create the report generated in FIG. 2. Storage of all map files, reports, and prescription files occurs on computer hard drives, flash drives, and remote online servers, in a manner that is common and known.

The foregoing is considered as illustrative only of the principles of the invention. The scope of the claims should not be limited by the preferred embodiments set forth in the foregoing examples, but should be given the broadest interpretation consistent with the specification as a whole.

1. A method for characterizing a field used for agricultural purposes, the method comprising:
a) collecting field attribute data representing a plurality of attributes characterizing the field;
b) using the field attribute data to generate a plurality of base maps, each base map illustrating at least one of the attributes;
c) combining the base maps to generate a plurality of zone maps such that each of the zone maps illustrates a unique combination of the attributes;
d) comparing each of the plurality of zone maps to field data; and
e) selecting the zone map that best reflects the field data.

2. The method of claim 1, further comprising:
f) using the selected zone map to identify management zones for variable-rate crop inputs.

3. The method of claim 1, further comprising:
g) using the selected zone map to determine a crop input prescription for the field.

4. The method of claim 1, wherein:
the attributes are relevant to crop input determinations.

5. The method of claim 1, wherein:
the attributes are selected from the group consisting of soil attributes, water attributes and topography attributes.

6. The method of claim 1, wherein:
each of the base maps illustrates a soil attribute, a water attribute or a topography attribute.

7. The method of claim 1, wherein:
the combining of base maps in c) is accomplished by incorporating data from selected base maps into a single zone map, thereby illustrating the unique combination of attributes represented by the selected base maps.

8. The method of claim 1, wherein:
the field data is derived from field observation or records.

9. The method of claim 4, wherein:
the crop input determinations are related to agricultural products selected from the group consisting of fertilizer products, seed products, pesticide products, soil remediation products, and combinations thereof.

10. The method of claim 1, wherein:
the field data comprises soil based field data and elevation based field data.

11. The method of claim 10, wherein:
the field data is soil-based data and is obtained using field surveys, soil sensors or remote sensing.

12. The method of claim 10, wherein:
the field data is elevation-based data and is obtained using in-field elevation data collection or remote sensing.

13. The method of claim 1, wherein:
each zone map illustrates a unique combination of the attributes by emphasizing visual presentation of such attributes.

14. The method of claim 5, wherein:
the soil attributes are selected from the group consisting of texture, organic carbon, organic matter, pH, structure, erosion, salt levels, topsoil depth, and combinations thereof.

15. The method of claim 5, wherein:
the water attributes are selected from the group consisting of water sheds, water flow paths, water collecting areas, water shedding areas, aspects and slopes, and combinations thereof.

16. The method of claim 5, wherein:
the topography attributes are selected from the group consisting of raw elevation, elevation variant combinations, knolls, shoulder slopes, mid-slopes, foot slopes, depressions and topography variant combinations, and combinations thereof.

17. The method of claim 6, wherein:
the base map illustrates a soil attribute and visually depicts one or more of the following: soil salt level, soil organic content, soil colour, soil carbon content, soil structure, soil texture, topsoil depth, soil pH, and soil erosion properties.

18. The method of claim 6, wherein:
the base map illustrates a water attribute and visually depicts one or more of the following: water shedding areas, water flow paths, water collecting areas, slopes, watersheds, and aspects.

19. The method of claim 6, wherein:
the base map illustrates a topography attribute and visually depicts one or more of the following: raw elevation, and elevation variants.

20. The method of claim 2, wherein:
each zone map illustrates management zones by means of a color code.

21. The method of claim 3, wherein:
the step g) includes obtaining field samples related to zones illustrated in the selected zone map.

22. The method of claim 3, wherein:
the step g) is accomplished either manually or through an automated process.

23. The method of claim 1, further comprising:
cleaning the data collected in a) prior to b).

24. A system for characterizing a field used for agricultural purposes, the system comprising:
means for receiving field attribute data representing a plurality of attributes characterizing the field;
a memory configured with a data structure for storing the field attribute data;
a processor in communication with the memory, the processor configured to use the data to generate a plurality of base maps, each base map illustrating at least one of the attributes;
the processor further configured to combine the base maps to generate a plurality of zone maps such that each of the zone maps illustrates a unique combination of the attributes;
the processor further configured to enable comparison of each of the plurality of zone maps to field data; and
the processor further configured to enable selection of the zone map that best reflects the field data.

25. The system of claim 24, wherein:
the selected zone map illustrates management zones for variable-rate crop inputs.

26. The system of claim 24, further comprising:
the processor is configured to determine a crop input prescription for the field based on the selected zone map.

27. The system of claim 24, wherein:
the attributes are relevant to crop input determinations.

28. The system of claim of 24, wherein:
the attributes are selected from the group consisting of soil attributes, water attributes and topography attributes.

29. The system of claim 24, wherein:
each base map illustrates a soil attribute, a water attribute or a topography attribute.

30. The system of claim 24, wherein:
the processor is configured to combine base maps by incorporating data from selected base maps into a single zone map, thereby illustrating the unique combination of attributes represented by the selected base maps.

31. The system of claim 24, wherein:
the field attribute data is obtained from a source selected from the group consisting of field soil surveys, soil sensors, remote sensing and in-field elevation data collection, and combinations thereof.

32. The system of claim 24, wherein:
the field data comprises soil based field data and elevation based field data.

33. The system of claim 24, wherein:
each zone map illustrates a unique combination of the attributes by emphasizing visual presentation of such attributes.

34. The system of claim 24, wherein:
the processor is further configured to clean the field attribute data before using the field attribute data to generate the plurality of base maps.

35. The system of claim 24, wherein:
the processor produces the zone maps using a color code.

36. The system of claim 26, wherein:
the memory is configured for receiving and storing soil sample data, and the processor is configured to use the soil sample data in generating the crop input prescription for the field.
